(19) United States
(12) Patent Application Publication
(10) Pub. No.: US 2023/0416544 A1
(43) Pub. Date: Dec. 28, 2023

(54) POLYMER/PHASE CHANGE MATERIAL COMPOSITE INK FOR THREE-DIMENSIONAL PRINTING BY DIRECT INK WRITING

(71) Applicant: The Texas A & M University System, College Station, TX (US)

(72) Inventors: Emily Pentzer, Bryan, TX (US); Peiran Wei, College Station, TX (US); Ciera Cipriani, College Station, TX (US)

(21) Appl. No.: 18/036,630

(22) PCT Filed: Nov. 19, 2021
(86) PCT No.: PCT/US2021/059995

§ 371 Date: May 11, 2023

Related U.S. Application Data
(60) Provisional application No. 63/115,257, filed on Nov. 18, 2020.

(51) Int. Cl. C09D 11/16; C09K 5/14; B29C 64/106; B33Y 70/00

(52) U.S. Cl. CPC C09D 11/16; C09K 5/14; B29C 64/106; B33Y 70/00

(57) ABSTRACT

In an embodiment, the present disclosure pertains to an ink composition. In some embodiments, the ink composition includes particles composed of a phase change material (PCM) and a resin. In an additional embodiment, the present disclosure pertains to a method of making an ink composition. In general, the method includes forming PCM beads from a PCM and loading a resin with the PCM beads. In a further embodiment, the present disclosure pertains to a method for forming a material or structure. In general, the method includes printing a composite ink on a substrate. In some embodiments, the composite ink includes particles composed of a PCM and a resin. In some embodiments, the method further includes curing the resin to thereby form the material or structure and imparting thermal regulation, by the composite ink, onto the material or structure.

### CROSS-REFERENCE TO RELATED APPLICATIONS

This patent application claims priority from, and incorporates by reference the entire disclosure of, U.S. Provisional Application No. 63/115,257 filed on Nov. 18, 2020.

### STATEMENT REGARDING FEDERALLY SPONSORED RESEARCH

This invention was made with government support under 1955170 awarded by the National Science Foundation. The government has certain rights in the invention.

### TECHNICAL FIELD

The present disclosure relates generally to three-dimensional (3D) printing and more particularly, but not by way of limitation, to polymer/phase change material composite inks for 3D printing by direct ink writing (DIW).

### BACKGROUND

This section provides background information to facilitate a better understanding of the various aspects of the disclosure. It should be understood that the statements in this section of this document are to be read in this light, and not as admissions of prior art.

Increasing world population, economic growth, and industrialization result in higher global demand for energy. Currently, fossil fuel combustion is the most utilized source of energy for human needs. In the United States, 20% of energy is consumed for the active thermal control of buildings, in which indoor temperature variations are moderated by heating, ventilation, and air conditioning. Unfortunately, the reliance on fossil fuels for these applications is met with resistance, both due to concerns of accessing such energy sources, as well as the negative environmental impacts of their combustion. As such, alternatives to active thermal control are a strategic target for sustainable global development, especially in the management of thermal energy. New technologies that reduce temperature fluctuations whilst maintaining desirable thermal comfort hold the potential to revolutionize the global energy landscape.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to an ink composition. In some embodiments, the ink composition includes particles composed of a phase change material (PCM) and a resin.

In some embodiments, the PCM can include, without limitation, an organic PCM, an inorganic PCM, and combinations thereof. In some embodiments, the particles are PCM beads that can include, without limitation, paraffin, n-eicosane, n-hexatriacontane, and combinations thereof. In some embodiments, the particles are rheology modifiers. In some embodiments, the ink composition has a wt:wt filler:resin ratio of 0.7:1 (41 wt % of the PCM) to 2:1 (67 wt % of the PCM). In some embodiments, the resin can include, without limitation, a liquid resin, a photocurable resin, a liquid photocurable resin, a photopolymerizable resin, an acrylate resin, a polymerizable resin, a cross-linkable resin, a curable resin, and combinations thereof. In some embodiments, the ink composition exhibits thermal regulation.

In an additional embodiment, the present disclosure pertains to a method of making an ink composition. In general, the method includes forming PCM beads from a PCM and loading a resin with the PCM beads. In some embodiments, the forming can include, without limitation, hammer milling, ball milling, jet milling, physical vapor deposition, chemical vapor deposition, emulsification, microfluidics, atomization, aerosol spraying, and combinations thereof.

In some embodiments, the PCM can include, without limitation, an organic PCM, an inorganic PCM, and combinations thereof. In some embodiments, the PCM beads can include, without limitation, paraffin, n-eicosane, n-hexatriacontane, and combinations thereof. In some embodiments, the PCM beads are rheology modifiers. In some embodiments, the loading includes forming a wt:wt filler:resin ratio of 0.7:1 (41 wt % of the PCM) to 2:1 (67 wt % of the PCM) in the ink composition. In some embodiments, the resin can include, without limitation, a liquid resin, a photocurable resin, a liquid photocurable resin, a photopolymerizable resin, an acrylate resin, a polymerizable resin, a cross-linkable resin, a curable resin, and combinations thereof. In some embodiments, the ink composition exhibits thermal regulation.

In a further embodiment, the present disclosure pertains to a method for forming a material or structure. In general, the method includes printing a composite ink on a substrate. In some embodiments, the composite ink includes particles composed of a phase change material (PCM) and a resin. In some embodiments, the method further includes curing the resin to thereby form the material or structure and imparting thermal regulation, by the composite ink, onto the material or structure.

In some embodiments, the PCM can include, without limitation, an organic PCM, an inorganic PCM, and combinations thereof. In some embodiments, the particles are PCM beads that can include, without limitation, paraffin, n-eicosane, n-hexatriacontane, a rheology modifier, and combinations thereof. In some embodiments, the composite ink has a wt:wt filler:resin ratio of 0.7:1 (41 wt % of the PCM) to 2:1 (67 wt % of the PCM). In some embodiments, the resin can include, without limitation, a liquid resin, a photocurable resin, a liquid photocurable resin, a photopolymerizable resin, an acrylate resin, a polymerizable resin, a cross-linkable resin, a curable resin, and combinations thereof. In some embodiments, the material or structure can include, without limitation, green building materials, spacecraft thermal storage, electronic components, and combinations thereof.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIGS. 1A-2B illustrates rheological behavior of inks composed of elastic photocurable resin with different loadings of paraffin wax beads. FIG. 1A shows apparent viscosity as a function of shear rate (data are truncated at the shear rates at which the ink aggregated and began to emerge from between the parallel plate). FIG. 1B shows storage modulus and loss modulus as a function of shear stress.

FIG. 2A illustrates a stress-strain curve for c-P-1.7. The inset compares elastic modulus of samples with different loading of phase change materials (PCMs). Samples are named as form-filler-ratio in which: 1) form is b=beads, i=ink, or c=cured ink; filler is P=paraffin, E=n-eicosane, H=n-hexatriacontane, or S=cornstarch; and the wt:wt filler:resin ratio is 1.2:1, 1.7:1, or 2:1 (e.g., i-P-1.7 refers to uncured paraffin ink with a weight ratio of 1.7:1 paraffin beads:resin).

FIG. 2B illustrates representative differential scanning calorimetry (DSC) profiles of b-P, c-P-1.7, and c-R.

FIG. 2C illustrates dimension change of printed and cured structures as a function of temperature ramp. The inset compares coefficient of thermal expansion (CTE) of c-R and c-P-c-P-1.2, c-P-1.7, and c-P-2 before and after the PCM melted.

FIG. 2D illustrates weight loss percentage of c-P-1.2 during an anti-osmosis (leakproofness) test in water at elevated temperatures.

FIGS. 3A-3C illustrates thermal regulation capability of hollow houses printed (approximately 100 mm×75 mm×100 mM with walls 10 mm thick) with acrylonitrile butadiene styrene (ABS), c-S-1.2, and c-P-1.2. FIG. 3A shows a schematic of how heating and temperature measurements were performed. FIG. 3B shows variation with time of the temperature inside the houses during heating and cooling. FIG. 3C shows temperature inside of the houses relative to the chamber during heating and cooling.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Phase change materials (PCMs) are an attractive option to passively control building heating and cooling. A facile method to produce and print PCM-filled inks by a direct ink writing (DIW) technique that leverages spherical PCM particles as viscosity modifiers in a matrix of curable resin is disclosed herein. Outlined below are print structures with up to 63 wt % PCM, which have excellent thermal regulation capacity and nearly no leakage over at least 200 melting/solidifying cycles. A hollow house printed with a PCM-filled ink maintained a 40% lower temperature than the external environment when heated. Furthermore, it is demonstrated herein that PCMs with different melting points can be simultaneously integrated into resin and printed without detriment to the structure or integrity. Thus, this approach to using PCM particles as both viscosity modifiers for three-dimensional printing (3DP) and passive thermal management to produce effective thermal buffers and is compatible with a wide range of polymer matrices (e.g., photopolymer matrices) and PCMs, without requiring prior microencapsulation of the PCM.

Thermal energy storage (TES) systems that utilize PCMs for latent heat storage are attractive options for the passive control of building heating and cooling, as they can be efficient and environmentally benign. PCMs absorb and release thermal energy through solid-solid, solid-liquid, or liquid-gas phase transformations within a well-defined temperature range. These materials have proven useful in many applications, such as battery thermal management, solar-heating systems, and cooling of electronics. For example, paraffin/expanded graphite composite heat sinks for electronic components have been produced. These composites achieved apparent heat transfer coefficients 1.25 to 1.3 times higher than a traditional metal heat sink. Alternatively, heat pipes, which typically have a hollow cylinder filled with a vaporizable liquid, are widely used as “thermal buffers” for lithium-ion batteries, computer systems, and battery systems of electric vehicles. In general, selection of a PCM for a given application is based on cost, operating temperature, heat of fusion per unit weight, thermal conductivity, and cyclability. Considering transformation temperature, energy storage density, and volume change, PCMs which undergo solid-liquid transformations are the most attractive choice for many systems, including thermal control of buildings and batteries.

To date, many solid-liquid PCMs have been developed and studied and can be classified as organic or inorganic. The most common organic PCMs are hydrocarbons, primarily paraffin waxes (CₙH₂ₙ₊₂) and their fatty acid and ester derivatives. On the other hand, inorganic PCMs, which include molten salts, metal alloys, and salt hydrates, have recently received increased attention for their higher energy storage density and thermal conductivity compared to organic PCMs. However, organic PCMs offer lower corrosivity and better compatibility with matrix materials, and they experience a lower degree of undercooling. Ultimately, inorganic and organic PCMs offer complementary properties and selection is based on the requirements of the intended application. Regardless of classification, all solid-liquid PCMs experience the limitations of loss of structural integrity and volume change upon melting. Another challenge in utilizing PCMs is the limited temperature range over which a single material performs its thermal regulation function.

A common approach to addressing the issues of leakage and volume change upon phase change is the microencapsulation of PCMs, and several successful approaches have been demonstrated. For example, the Pickering emulsion-templated encapsulation of stearic acid in a shell of graphene oxide nanosheets crosslinked by ethylenediamine has been demonstrated. This core-shell structure prevented leakage of the molten PCM and improved its thermoregulation properties; furthermore, these capsules were stable to multiple heating-cooling cycles. In a similar vein, methyl laurate was encapsulated in a composite of hydrophobized cellulose nanocrystals and poly(urea-urethane), which formed rigid shells that inhibited leakage. Such rigid microcapsules of PCMs can be integrated into building materials such as concrete, polymer binder, and gypsum to produce monolithic structures. Furthermore, a six-sided cubicle, with three of the walls containing 5 wt % of microencapsulated PCM in a concrete matrix was built. Compared to the control cubicle, the PCM-loaded cubicle mitigated temperature fluctuations with a 1° C. lower maximum temperature and 2° C. higher minimum temperature, and postponed the maximum temperature until two hours later. These findings demonstrate the benefits of the thermal buffer and thermal inertia effects of encapsulated PCMs when incorporated into building materials. However, for widespread integration and application, capsule formation must not have prohibitively complex manufacturing needs or costs, and the shell should have limited impact on energy storage density.

Building materials and infrastructure have benefitted from the recent progress in 3DP technologies. 3DP offers distinct opportunities to integrate active materials into monolithic structures, provided appropriate feedstock compositions can be realized. Further, 3DP can produce objects with complex geometries, such as decorative non-load bearing pieces, allowing for thermal energy storage materials to be incorporated into existing structures. Among different 3DP techniques, direct ink writing (DIW) has become one of the most used strategies due to its low cost, ease of use, and the ability to tailor ink compositions. DIW inks must be shear-thinning and highly viscous to hold their shape after extrusion. To date, ink compositions have included colloidal gels/suspensions, polymers, ceramics, and nanoparticles. The viscosity of an ink for 3DP has been found to depend on the concentration of particle additives, thus it was hypothesized that particles of solid PCM can be used as viscosity modifiers to produce DIW inks. Such feedstocks would enable the rapid and scalable production of three-dimensional (3D) printed functional monolithic structures with applications in thermal energy management of buildings, without requiring the encapsulation step beforehand.

As such, presented herein is a facile method to produce and print PCM-filled inks by DIW by leveraging spherical PCM beads as viscosity modifiers in a curable resin matrix. PCM beads were produced by emulsifying at elevated temperatures, then dispersed in commercially available acrylate resin, printed, and cured with ultraviolet light. In such systems, PCM beads serve a twofold purpose of modifying ink rheology and imparting thermal energy management properties. The photopolymerization leads to elastic containment of the PCM without the use of a shell material. Based on this design concept, structures with up to 63 wt % PCM with excellent thermal regulation capacity and nearly no leakage during multiple heating and cooling cycles, were successfully printed. Since ink formulation is independent of the identity of the PCM, multiple PCMs can be incorporated into a single ink. This allows for a wider operating temperature window and increases the thermal management capabilities of the structure. Herein, it is demonstrated that PCMs with different melting points (n-eicosane, paraffin wax, and n-hexatriacontane) can be simultaneously integrated into the resin and printed without detriment to integrity. This method harnesses the advantages of DIW and eliminates issues inherent in current microencapsulation techniques—namely, fluid leakage upon volume change—to facilitate the incorporation of PCMs into building materials. The excellent adaptability of DIW makes it compatible with a wide variety of polymer matrix materials, offers the ability to tailor the loading of PCM particles to achieve desired thermal energy management performance, and gives control over the structure of the printed objects. This approach greatly simplifies manufacturing and decreases costs.

In view of the aforementioned, various embodiments of the present disclosure are directed towards materials and/or structures, that can include, without limitation, green building materials, spacecraft thermal storage, electronic components (e.g., heatsinks), materials for resin development (e.g., organogel/hydrogel), and combinations of the same and like. In addition, various embodiments of the present disclosure pertain to an ink composition. In some embodiments, the ink composition includes particles composed of a PCM and a resin. Further embodiments of the present disclosure pertain to a method of making an ink composition. In general, the method includes forming PCM beads from a PCM and loading a resin with the PCM beads. In some embodiments, the forming can include, without limitation, hammer milling, ball milling, jet milling, physical vapor deposition, chemical vapor deposition, emulsification, microfluidics, atomization, aerosol spraying, and combinations thereof. Additional embodiments the present disclosure pertain to a method for forming a material or structure. In general, the method includes printing a composite ink on a substrate. In some embodiments, the composite ink includes particles composed of a PCM and a resin. In some embodiments, the method further includes curing the resin to thereby form the material or structure and imparting thermal regulation, by the composite ink, onto the material or structure.

### Working Examples

Reference will now be made to more specific embodiments of the present disclosure and data that provides support for such embodiments. However, it should be noted that the disclosure below is for illustrative purposes only and is not intended to limit the scope of the claimed subject matter in any way.

PCM Particles Impart Thixotropy to Photocurable Resin. Ideal inks for DIW should be thixotropic so that they are shear thinning and can be extruded, then quickly thicken to hold their shape. Typically, photocurable resins are Newtonian liquids, but nanofiller additives can impart non-Newtonian, thixotropic behavior. The use of PCM microbeads as rheology modifiers was chosen and is examined herein. To this end, beads of paraffin wax (m.p.=58-62° C.) with an average diameter of 33 μm were prepared by emulsification at 80° C. in water, in the presence of the surfactant SPAN® 20. These PCM beads were incorporated into a photocurable resin by hand mixing until a homogenous ink was produced. Five photocurable resins were screened for ink formulation, and Formlabs Elastic resin was selected as it provides optimal rheological performance for printing and produces well-sealed PCM-containing structures that were stable to multiple heat-cooling cycles. Microbeads of two additional PCMs, n-eicosane (m.p.=36-38° C.) and n-hexatriacontane (m.p.=74-76° C.), were used as fillers to achieve thermal regulation across different temperature ranges. Further, a non-PCM ink analog was prepared as a control by mixing cornstarch powder with the resin, since the resin itself is not viscous enough to be printed. For the data discussed below, the samples are named as form-filler-ratio in which: form is b=beads, i=ink, or c=cured ink; filler is P=paraffin, E=n-eicosane, H=n-hexatriacontane, or S=cornstarch; and the wt:wt filler:resin ratio of 0.7:1, 1.2:1, 1.7:1, or 2:1. For example, b-H refers to beads of n-hexatriacontane, i-P-1.7 refers to uncured paraffin ink with a weight ratio of 1.7:1 paraffin beads:resin, and c-R refers to cured resin without filler.

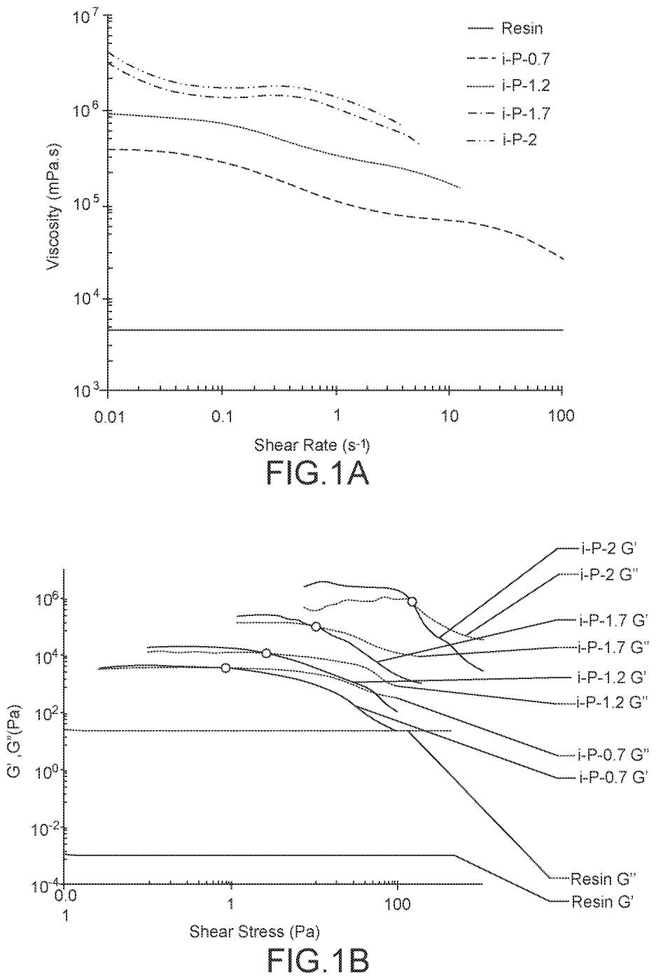

The printability of inks with different PCM loadings was primarily evaluated by viscosity and yield stress. As displayed in FIG. 1A, the as-received photocurable resin was a Newtonian liquid as expected, with a viscosity that was independent of shear rate. Incorporating PCM beads into this resin imparted shear-thinning behavior, whereby the viscosity decreased as the shear rate increased. The loading of PCM beads was varied based on the weight ratio of wax to resin, from 0.7:1 to 2:1 (41 to 67 wt % PCM, respectively). In general, increasing the filler concentration increased the viscosity but had little effect on the magnitude of the shear-thinning behavior (i.e., the slope). For example, at a shear rate of 4.09 s⁻¹, a viscosity of 7.4×10⁴ mPa s was observed for i-P-0.7, and 6.5×10⁵ mPa s was observed for i-P-2. This indicates that inks can be formulated to achieve optimal thixotropic behavior for DIW printing, since materials undergo shear during the extrusion process.

As shown in FIG. 1B, increasing the loading of PCM beads increased the yield stress, which improved the ability of the ink to hold its shape after extrusion. For example, i-P-0.7 did not have a high enough yield stress (0.52 Pa) to hold its shape after extrusion; therefore, the ink drips from the spatula. The samples i-P-1.2 and i-P-1.7 looked like pastes and retained their shapes on a spatula after inversion. However, further increasing the loading of PCM led to a granular ink that did not form a homogenous paste on the spatula tip (e.g., i-P-2). Thus, an upper limit to the loading of PCM exists for a composition to be printable. With this information, i-P-1.2 and i-P-1.7 were chosen for printing, although similar, and intermediate, ratios should also be printable.

PCM Particles are Encapsulated by Photopolymer Resin in Printed Objects. Having established appropriate ink compositions for DIW printing, a Hyrel 3D Engine SR with a fixed layer height of 0.6 mm and an extrusion rate of 20 mL/h was used to print i-P-1.2 and i-P-1.7. After each layer was printed, ultraviolet (UV) light was used to cure the resin. Since the resin exhibits strong cyan fluorescence under 405 nm light and the PCM filler has no fluorescence, confocal microscopy was used to characterize the morphology of the cured PCM/resin composites. The letters “T”, “A”, “M”, and “U” were printed and cured utilizing c-P-1.7, and confocal microscopy images of the c-P-1.7 letters were analyzed. The PCM particles appear as darker, spherical regions surrounded by a light gray color, which is the resin. As the loading of PCM particles increased, a higher concentration of darker regions is observed. Breaking the c-P-1.7 sample and imaging the cross-section scanning electron microscopy (SEM) shows spheres and voids at the surface. These data support the presence of pockets of PCM surrounded by cured resin with the PCM particles homogeneously dispersed throughout the polymer matrix, suggesting that each particle is encapsulated within the monolithic structure.

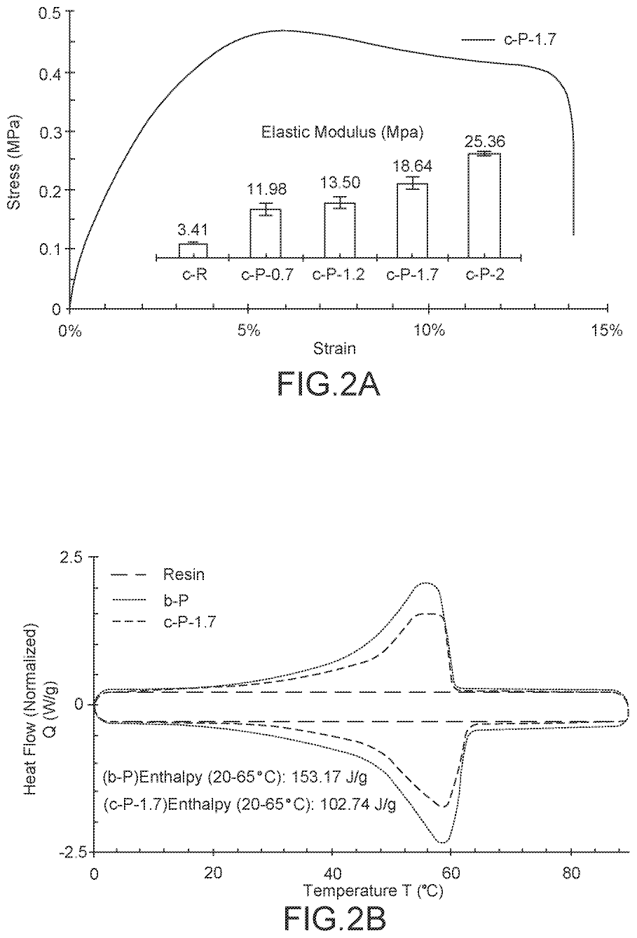

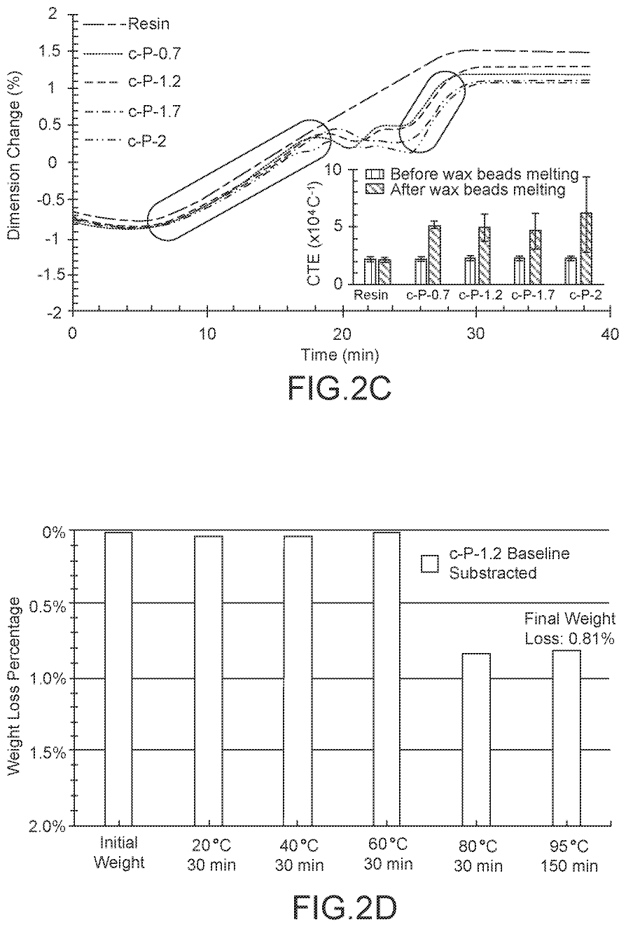

Increasing PCM Loading Increases Elastic Modulus. The impact of ink composition on the mechanical properties was then evaluated. Dog bone-shaped tensile samples of each ink were cast according to ASTM Die C specifications and cured by UV light, then strained at a rate of 0.3 m⁻¹ with a 1 kN load cell. A representative stress-strain curve of c-P-1.7 and a bar plot of the elastic moduli are shown in FIG. 2A. The elastic modulus and strain at break of c-R were 3.4 MPa and 43%, respectively, which indicates that the resin exhibits good elasticity. With increased loading of PCM beads, both the yield stress and modulus increased. This behavior was expected and corresponds to the predictions of several models. The elastic modulus of c-P-2 (67 wt % PCM beads) was five times that of c-R and as the loading of PCM beads increased, the strain at break decreased accordingly. Thus, the PCM loading level dictates the mechanical properties of the resulting printed structure, and there is a tradeoff between elastic modulus and strain at break.

To further evaluate the impact on thermal cycling on the mechanical properties of the samples, compression tests were conducted on c-R, c-S-1.7, and c-P-1.7 before and after 100 and 200 thermal cycles when submersed in water. For the resin alone (c-R), the modulus was constant regardless of how many cycles the sample was subjected to, whereas for c-S-1.7, a slight decrease in modulus (˜10%) was observed as the number of thermal cycles increased. This is attributed to the hydrophobicity and thermal stability of the resin, and absorption of water by cornstarch filler, the latter of which causes swelling of the particles and poor adhesion between particle and matrix. In contrast, c-P-1.7 increased in modulus with more thermal cycles (˜25%), which may be attributed to better wetting of the cured resin by the PCM. The majority of change in modulus for c-S-1.7 and c-P-1.7 occurred after the first 100 cycles, which indicates conditioning after initial thermal cycling, after which consistent mechanical performance is observed. Thus, extensive degradation of the mechanical performance of c-S-1.7 and c-P-1.7 was not observed.

PCM Thermal Performance is Conserved within Printed Structures. The differential scanning calorimetry (DSC) thermal profiles of paraffin wax beads (b-P), printed and cured paraffin ink (c-P-1.7), and cured neat resin (c-R) are shown in FIG. 2B; these data give insight into the impact of PCM containment and sample composition. Both the pure wax beads and c-P-1.7 show a broad endothermic region from 45 to 65° C., with a peak at 55-57° C. that corresponds to the paraffin melting temperature. This peak indicates that the wax beads within the cured resin have the same thermal behavior as the pure wax. Similar results were obtained for n-eicosane and n-hexatriacontane, whereby the same endothermic regions were observed for the PCM beads and inks. The DSC thermogram of pure resin is featureless, which corroborates the finding that the wax melting is responsible for any thermal energy management behavior of the materials herein. These data also support that pure domains of PCM exist within the cured resin, enabling the performance of the PCM to be conserved within the monolithic structure. Increasing the loading of PCM in an ink proportionally increases the amount of heat that can be stored and released by an object made from cured ink. Subjecting c-P-1.7 to 200 heating/cooling cycles revealed no change in the DSC profile, suggesting that the thermal management capability is stable and no significant morphological changes occur.

PCM Influences Thermal Expansion Only Above Melting Temperature. Thermal expansion is a common concern when incorporating PCMs into building materials. Paraffins are known to have a relatively large volume change when transitioning between the solid and liquid phases (˜15%). Therefore, the linear thermal expansion of cured inks with different loadings of paraffin beads using a thermomechanical analyzer (TMA) was studied. FIG. 2C shows the plot of dimension change of different samples versus time at a temperature ramp of ° C./min after 5 minutes of equilibration at −25° C. Two distinct regions corresponding to different rates of dimensional change are identified. The resin had a constant linear coefficient of thermal expansion (CTE) over the range of temperatures tested. All cured paraffin-containing inks showed two regions of thermal expansion; the first region, between ˜20 and 25° C., is consistent across all samples and is attributed to the resin. For all inks containing PCM beads, a plateau in dimension change is observed from 45 to 65° C. as the PCM melts. The second region of thermal expansion is between 72 and 79° C. and is consistent across all PCM-containing inks. This region is not present in the resin. Thus, below the PCM melting point, the resin is the main contributor to CTE of cured inks, and above the PCM melting point, the PCM melts and contributes to the material expansion. Therefore, an increased rate of dimension change and increased CTE is observed between 72 and 79° C.

Polymer-PCM Composites Exhibit Minimal PCM Leakage. The leakproofness of a PCM-containing structure, especially above the melting point of the PCM, is another important property for applying these materials in thermal energy management. Poor anti-osmosis performance may result in gradual permeation of liquid PCM out of the matrix (i.e., a leaky system), resulting in a decrease in energy storage density over time. Therefore, an anti-osmosis measurement was performed to evaluate the leakproofness by submerging samples in water and increasing the temperature, as well as alternating the samples between surfactant solutions and acidic and basic buffers at elevated temperatures. When immersed in water, the weight of both c-R and c-P-1.2 decreased slightly at room temperature (20° C.), and this weight loss increased at elevated temperatures. To determine contribution of the weight loss due to PCM, the weight loss of c-R was subtracted from the weight loss of c-P-1.2. As shown in FIG. 2D, after baseline subtraction, the PCM-containing ink began losing weight in water only above 80° C., and <1% weight loss observed, even after heating in water at 95° C. for more than 150 min. Similar experiments in the presence of surfactants and different pH reveal only ˜0.8% weight loss after the first 100 cycles and ˜1.8% after 200 cycles. Analysis of the cycled samples by SEM imaging of the fractured surface indicates that the initial morphology is maintained and the PCM particles are present. Thus, neither the presence of surfactant nor changes in pH dramatically increase PCM leakage.

Different PCMs Provide Tailorable Thermal Performance. To evaluate the thermal energy storage capacity of the PCM-filled printed structures, the letters “T”, “A”, “M”, and “U” were 3D printed. Each of the letters contained an ink with a different type of PCM, or a mixture thereof. “A” was composed of c-E-1.2 (m.p. of n-eicosane is 36-38° C.), “M” was composed of c-P-1.2 (m.p. of paraffin is 58-62° C.), and “U” was composed of c-H-1.2 (m.p. of n-hexatriacontane is 74-76° C.). “T” was composed of c-EPH-1.2, so the PCM component was an equal mixture of the three PCMs. A substrate for these letters was prepared from c-S-1.7 (i.e., the substrate was not expected to have thermal energy storage activity and provided a contrast to the PCM-containing letters). The extruded filaments are 0.85-0.90 mm in diameter with an interspace of 0.85-0.90 mm, as determined by SEM. In the high magnification images, protuberances can be found across the surface, indicating PCM particles near the surface.

The thermoregulation performance of the printed PCM-filled structures was observed clearly through an infrared (IR) camera to visualize the different temperatures of the printed pieces. To evaluate these materials, the assembled printed samples were first cooled to −10° C., then transferred to a hotplate held at 100° C. As the temperature of the substrate increased to 57.3° C., the “A” showed a notably lower temperature. As the temperature increased further, the n-eicosane beads in “A” fully melted; therefore, no difference in color between the letter and the substrate was observed in the thermal image. The “M” began this cycle as the substrate approached the melting point of paraffin. Over time the c-S-1.2 substrate temperature increased up to 80.2° C. while the “M” held a much lower temperature due to the absorption of thermal energy during the paraffin melting. Finally, “U” began exhibiting thermal energy absorption when the substrate approached the melting point of n-hexatriacontane. “M” and “U” maintained lower temperatures than the substrate, even as the substrate reached 91.6° C. “T”, which contained a mixture of all 3 PCMs, also demonstrated thermal regulation ability by maintaining a lower temperature than the substrate across the entire temperature range tested. Thus, multiple PCMs can be combined within a single ink to increase the temperature range of thermal regulation of printed structures.

When the heated letters and substrate were removed from the hotplate and allowed to return to room temperature, the letters exhibited the reverse behavior than that observed upon heating. The PCM containing regions remained at higher temperatures as the c-S-1.2 substrate decreased in temperature. “U” released heat first which corresponded to solidification of n-hexatriacontane. Next, “M” released heat next corresponding to the freezing of paraffin. Finally, the letter “A” released heat during the freezing of n-eicosane beads. “T” steadily released heat throughout the entire temperature range. Thus, the distribution of beads of PCM in structures enables the objects to possess excellent thermoregulation performance during both heating and cooling.

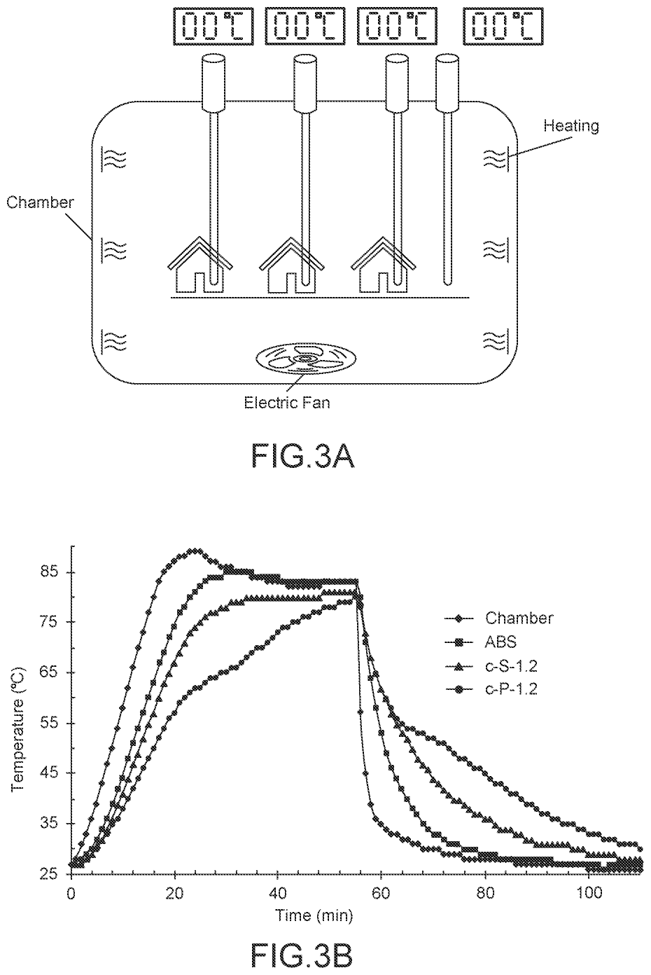

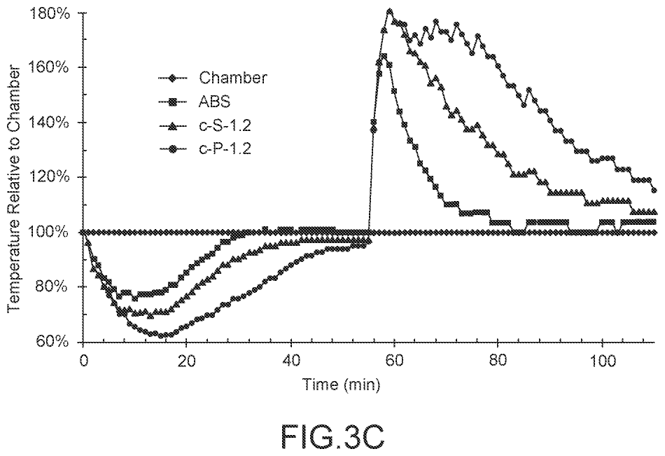

PCM-Polymer Composites Have Superior Thermoregulation Capability to Conventional 3D Printing Materials. To further illustrate the impact of the incorporation of PCM beads into 3D printed structures, three different small houses with (1) commercial acrylonitrile butadiene styrene (ABS), (2) c-P-1.2, and (3) c-S-1.2 were printed and cured. Commercial ABS was used to demonstrate the performance of a typical thermoplastic used for fused filament fabrication 3D printing. The c-S-1.2 house allowed for the determination of the thermoregulation capability of the resin matrix itself, which was compared to that of the c-P-1.2 house. The printed houses were hollow and had approximately 10 mm thick walls. FIG. 3A contains a schematic of the heating and temperature measurement setup: the houses were placed in an oven in which an electric fan circulated hot air, and one thermocouple was inserted into each house while another thermocouple measured the chamber temperature. The chamber was heated to 80° C. and held until the interior of every house reached approximately 80° C., at which point the heat was shut off, and the chamber door was opened to allow the houses to passively cool to room temperature. As shown in FIG. 3B, during heating, the PCM-filled house exhibited a significant delay in temperature increase compared to the other two houses, which did not contain PCM. Alternatively, during cooling the PCM-containing structure more slowly returned to ambient temperature, which correlates with the results of the IR camera experiment, discussed above. FIG. 3C shows that the PCM-containing house maintains a 40% lower temperature than the external environment, and a 10-20% lower temperature than the control houses during heating. Thus, PCM-filled printed structures mitigate temperature fluctuations and can minimize the heating and cooling needed to maintain a constant temperature. The house made of c-P-1.2 also maintained its shape and structure, proving its stability at elevated temperatures.

Conclusion. In summary, disclosed herein is a facile method to produce and print PCM-filled structures by the DIW technique that leverages spherical PCM particles as viscosity modifiers in a matrix of curable resin. The effect of ink composition on viscosity to optimize printability and performance in thermal energy management was evaluated. Microscopy images of the cured structures revealed the homogeneous dispersion and full encapsulation of PCM beads within the resin matrix. A leakproofness test and DSC thermograms also demonstrated that the resin matrix effectively encapsulated the PCM during multiple solid-to-liquid phase change cycles, and that leakage of the molten PCM was negligible. The enthalpy of phase transformation was determined to be directly related to the loading of PCM beads. As ink formulation is not dependent on the identity of the PCM, multiple PCMs were incorporated into a single ink, allowing for a wider operating temperature window and increased thermal management capabilities. These advances in ink formulation enabled formation of 3D printed hollow houses that served as effective thermal buffers across the melting temperature range of the PCM and with superior thermal buffer performance compared to structures without PCM filler. The 3D printed houses mitigated temperature fluctuations with a 10% lower temperature during heating and 40% higher temperature during cooling than the houses without PCM. This method eliminates the need to microencapsulate PCMs before integration into a composite, enabling effective passive thermal management using readily available materials, and decreasing the manufacturing costs.

The excellent adaptability of DIW makes this approach compatible with a wide variety of polymer matrix materials, offers the ability to tailor the loading level of different PCM particles to achieve desired thermal energy management performance, and gives control over the geometry of the printed objects. This approach facilitates the production of PCM-containing structures with complex geometries, such as cooling fins in air conditioning units and replicas of architectural details for retrofitting existing buildings with thermal energy storage materials. The same design concept can be extended to other fields, such as passive thermal management in spacecraft and electronics. It is envisioned that diversifying the PCM filler used and resin selection can increase thermal conductivity and reduce flammability of the composites. Information regarding the materials and methods related to the above-illustrated examples are presented herein below.

Materials. Corn starch was ordered from Amazon. The photocurable resin, Elastic, was ordered from Formlabs. n-Eicosane was purchased from Thermofisher; n-hexatriacontane was ordered from VWR; sodium dodecyl sulfate was obtained from Oakwood Chemical; and paraffin wax, SPAN® 20, and TWEEN® 20 were ordered from Sigma-Aldrich. All chemicals were used as received.

Instrumentation. Optical microscopy images were taken using an AmScope 150C-2L microscope with an 18 MP USB 3.0 camera. SEM images were taken with a TESCAN VEGA SEM. The size distribution of b-P was performed with a Horiba Partica LA-960 particle sizer at the Materials Characterization Facility. DSC was performed using a DSC 2500 (TA Instruments) in the ramp mode (ramp 10° C./min to 90° C., isothermal for 1 min, and then ramp ° C./min to 0° C.) using aluminum pans. Thermal properties were analyzed at the third heating cycle. Rheological properties were analyzed using an Anton Parr MCR 302 rheometer with a mm parallel plate at 25° C., with a gap distance of 1 mm 3D printing was performed on a Hyrel 3D Engine SR. Thermal expansion was measured using a TA Instruments Q400 thermomechanical analyzer at 0.020 N of force over a temperature range of −30 to 80° C., with a ramp rate of 5° C./min and holding at 80° C. for 10 minutes to ensure melting was complete. Tensile samples of the resin and inks were cast in molds according to ASTM Die C specifications and cured by UV light. Compression samples were cast in cylindrical molds and cured by UV light. Stress-strain profiles were collected on an Instron 5943 Universal Testing System with a 1 kN load cell at a crosshead speed of 20 mm/min for both tension and compression. The images were recorded with a 320×240 IR resolution IR camera (HT-A2, Hti). Optical images of the printed inks and printed objects were recorded using an iPhone X.

Preparation of Wax Beads. 0.5 mL SPAN® 20 was dissolved in water (800 mL), and paraffin wax pellets (50 g) were added. The resulting mixture was heated to 80° C. to melt the wax. A high-shear emulsifier, set at 6,000 rpm for 3 min, was used to form a wax-in-water emulsion. When the emulsion returned to room temperature, solid, spherical wax beads were collected by gravity filtration and washed with methanol. The wax beads were dried under vacuum at room temperature overnight. The same procedure was followed to produce the n-eicosane and n-hexatriacontane wax beads, except the mixture was heated to 50° C. to melt the n-eicosane and 90° C. to melt the n-hexatriacontane. For n-hexatriacontane, TWEEN® 20 was used in place of SPAN® 20.

Inks Preparation and 3D Printing. In a 20 mL scintillation vial wrapped with aluminum foil, dry wax beads were added to Formlabs Elastic resin. The mixture was thoroughly homogenized by hand mixing and loaded into a 5 mL syringe for 3D printing. Control inks were prepared in the same way but with corn starch powder in place of the PCM particles. To print the inks, each ink was charged into a 5 mL syringe equipped with a 12 G nozzle (2.16 mm inner diameter). The loaded syringes were then placed on the extrusion cartridge of the 3D printer, and objects were printed onto a glass bed with a fixed layer height of 0.6 mm, extrusion rate of 20 mL/h, and infill of 70% crosslinked via in situ UV exposure after each layer. In general, the printed filament should be <5 mm in diameter for complete cure. 40%-infilled cubic lattices were also 3D printed using the same process as above, except with an 18 G nozzle (0.84 mm inner diameter).

Anti-osmosis Performance Study. Cured resin (c-R) and paraffin ink (c-P-1.2) were fully submerged into water at 20, 40, 60, 80, and 95° C. for 30 or 150 minutes. Samples were then taken out from the water, wiped with a KIMWIPE™, and fully dried in a vacuum oven at room temperature. The final weight of each sample was recorded.

A thermally cycled anti-osmosis study was also performed. Cylindrical samples of c-P-1.7 (5 mm diameter×10 mm height) were alternately immersed in SPAN 20® aqueous solution (above critical micelle concentration (CMC)) and citric acid/sodium citrate buffer solution (pH=5.6) for 100 thermal cycles between 15 and 95° C., and then alternately immersed in a solution of sodium dodecyl sulfate and cetyl trimethyl ammonium bromide (above CMC) and Na₂CO₃/NaHCO₃ buffer solution (pH=9.2) for another 100 thermal cycles. Samples were then removed from the solution, wiped with a KIMWIPE™, and fully dried in a vacuum oven at room temperature. The final weight of each sample was recorded. A thermal degradation experiment was conducted using the same procedure as the thermally cycled anti-osmosis study, but with samples alternately placed in water at 95° C. and water at room temperature, without using surfactants or buffer solutions.

Thermal Performance of Printed Structures. IR thermal images were recorded with a 320×240 IR resolution IR camera (HT-A2, Hti). The substrate of the TAMU logo was printed with i-S-1.7, and “A”, “M”, and “U” were printed with i-E-1.2, i-P-1.2, and i-H-1.2, respectively. “T” was printed with an equal ratio of i-E-1.2, i-P-1.2, and i-H-1.2. The letters were then inserted into the substrate and the seams, and gaps between the letters and substrate were filled with the corresponding ink and cured. The entire sample was then placed on a preheated (100° C.) hotplate wrapped with foil, and the temperature was measured during heating and cooling back to room temperature.

The thermal buffer effect of incorporating PCMs into printed structures was evaluated by printing house models from i-P-1.2 and i-S-1.2. These models were heated to 80° C. and allowed to passively return to room temperature in a Thermo Scientific Heratherm OGS60 oven. The temperature within each house was measured alongside the ambient temperature each minute.

Methods for Preparing Sub-Millimeter PCMs. Sub-millimeter-sized particles of a given solid-liquid PCM can be prepared by a variety of methods using a PCM in the solid or molten state. For PCMs in the solid state, these methods include, but are not limited to, physical methods, such as, hammer milling, ball milling, and jet milling. In hammer milling, the PCM is impacted by hammers, causing the PCM to fracture. This process is repeated, and PCM particles which are small enough to pass through a mesh screen are collected. Rather than using hammers to break up solid PCM, a ball mill uses balls having a grinding medium such as steel or ceramic. Bulk PCM can be added to a ball mill and ground to produce small particles, with the PCM particle size controlled by the size of the grinding medium. In jet milling, the particles themselves contribute to the milling process. Particles are impacted into one another by a jet of air, causing large particles to fracture until a desired size is achieved, which can be on the micrometer scale.

Physical and chemical vapor deposition methods can be harnessed to form solid PCM particles from PCMs in either the solid or molten state. In physical vapor deposition, the surface of a solid or liquid PCM is vaporized or ionized, then deposited onto a substrate and solidifies. Chemical vapor deposition involves flowing a gas-phase PCM or PCM precursor over a substrate, where the gas either adsorbs directly onto the substrate or undergoes gas-phase reactions, the products of which adsorb onto the substrate. Reactions may occur on the substrate before the final powder product is formed. In both physical and chemical vapor deposition processes, nucleation of adsorbed species can be harnessed to form solid particles.

Techniques for producing solid particles from PCMs in the molten state include emulsification, microfluidics, atomization, and aerosol spraying, for example. In the case of emulsification, a PCM is added to an immiscible liquid above the PCM melting point, and a suitable surfactant is added to the system. Emulsification of the two liquids forms droplets of PCM which solidify upon cooling below the PCM melting point, previously demonstrated to be on the scale of tens of micrometers. In a similar manner, a PCM above its melting point can be manipulated within a microfluidics system to produce PCM droplets which form sub-millimeter-sized particles when cooled below the melting point. Discrete particles can be achieved by pushing liquid PCM out of a microfluidic orifice at a low flow rate and allowing the droplets to land on a surface and solidify, pushing liquid PCM out of a microfluidic orifice and into a pool of an immiscible liquid, or by producing a stream of molten PCM which is broken into droplets by cool air or an immiscible liquid, for example. Molten PCM may be formed into spherical droplets by atomization methods, where the bulk liquid is transformed into a spray. One example is ultrasonic atomization, where a stream of molten PCM falls onto an ultrasonic surface, which produces PCM droplets at the fluid surface. These PCM droplets can then return to below the melting point to obtain PCM particles on the scale of hundreds of micrometers. Centrifugal force can also be used for atomization, whereby molten PCM is dispensed onto a rotating disk, and droplets fly off the edges of the disk and solidify midair or through contact with a cool surface, liquid, or gas.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

What is claimed is:

1. An ink composition comprising:
particles composed of a phase change material (PCM); and
a resin.

2. The ink composition of claim 1, wherein the PCM is selected from the group consisting of an organic PCM, an inorganic PCM, and combinations thereof.

3. The ink composition of claim 1, wherein the particles are PCM beads selected from the group consisting of paraffin, n-eicosane, n-hexatriacontane, and combinations thereof.

4. The ink composition of claim 1, wherein the particles are rheology modifiers.

5. The ink composition of claim 1, wherein the ink composition comprises a wt:wt filler:resin ratio of 0.7:1 (41 wt % of the PCM) to 2:1 (67 wt % of the PCM).

6. The ink composition of claim 1, wherein the resin is selected from the group consisting of a liquid resin, a photocurable resin, a liquid photocurable resin, a photopolymerizable resin, an acrylate resin, a polymerizable resin, a cross-linkable resin, a curable resin, and combinations thereof.

7. The ink composition of claim 1, wherein the ink composition exhibits thermal regulation.

8. A method of making an ink composition, the method comprising:
forming phase change material (PCM) beads from a PCM;
wherein the forming is selected from the group consisting of hammer milling, ball milling, jet milling, physical vapor deposition, chemical vapor deposition, emulsification, microfluidics, atomization, aerosol spraying, and combinations thereof; and
loading a resin with the PCM beads.

9. The method of claim 8, wherein the PCM is selected from the group consisting of an organic PCM, an inorganic PCM, and combinations thereof.

10. The method of claim 8, wherein the PCM beads are selected from the group consisting of paraffin, n-eicosane, n-hexatriacontane, and combinations thereof.

11. The method of claim 8, wherein the PCM beads are rheology modifiers.

12. The method of claim 8, wherein the loading comprises forming a wt:wt filler:resin ratio of 0.7:1 (41 wt % of the PCM) to 2:1 (67 wt % of the PCM) in the ink composition.

13. The method of claim 8, wherein the resin is selected from the group consisting of a liquid resin, a photocurable resin, a liquid photocurable resin, a photopolymerizable resin, an acrylate resin, a polymerizable resin, a cross-linkable resin, a curable resin, and combinations thereof.

14. The method of claim 8, wherein the ink composition exhibits thermal regulation.

15. A method for forming a material or structure, the method comprising:
printing a composite ink on a substrate;
wherein the composite ink comprises particles composed of a phase change material (PCM) and a resin;
curing the resin to thereby form the material or structure; and
imparting thermal regulation, by the composite ink, onto the material or structure.

16. The method of claim 15, wherein the PCM is selected from the group consisting of an organic PCM, an inorganic PCM, and combinations thereof.

17. The method of claim 15, wherein the particles are PCM beads selected from the group consisting of paraffin, n-eicosane, n-hexatriacontane, a rheology modifier, and combinations thereof.

18. The method of claim 15, wherein the composite ink has a wt:wt filler:resin ratio of (41 wt % of the PCM) to 2:1 (67 wt % of the PCM).

19. The method of claim 15, wherein the resin is selected from the group consisting of a liquid resin, a photocurable resin, a liquid photocurable resin, a photopolymerizable resin, an acrylate resin, a polymerizable resin, a cross-linkable resin, a curable resin, and combinations thereof.

20. The method of claim 15, wherein the material or structure is selected from the group consisting of green building materials, spacecraft thermal storage, electronic components, and combinations thereof.
